(19) United States
(12) Patent Application Publication
(10) Pub. No.: US 2009/0140530 A1
(43) Pub. Date: Jun. 4, 2009

(54) Dortye

(75) Inventor: Timothy Alen LePage, Panama City, FL (US)

Correspondence Address: Timothy LePage, 609 Lagoon Oaks Cir., Panama City Beach, FL, 32408, US

(73) Assignee: Timothy Alen LePage, Panama City, FL (US)

(21) Appl. No.: 11/999,209

(22) Filed: Dec. 3, 2007

(51) Int. Cl. E05C 1/06; E05B 1/00; E05C 21/02

(52) U.S. Cl. 292/38; 292/347

(57) ABSTRACT

A flexible folding doorknob latch piston molded to size. With fmgers folded, this doorknob latch piston, can be installed, into, the latch piston borehole. With latch piston installed, it will work as a doorknob, to latch a door closed. To strap the door jam to the door for shipping, install a headed, locking, strap tie. This helps to prevent door damages.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, and OR A COMPUTER PROGRAM LISTING COMPACT DISC APPENDIX

Not applicable

### BACKGROUND OF THE INVENTION

I created the Dortye for the construction industry, for the manufacturing of pre-hug doors. It will help strap a door for shipping, and work as a temporary doorknob.

Installing a door into a door jam is the process of building a pre-hung door. The way to secure a jam to the latch side of a door, for shipping, was to put screws or nails threw the jam and into the edge of the door. This damaged the edge of the door.

The Dortye solves this problem. By installing the Dortye into the doorknob piston, latch completely. The headed lock tie, put threw the jam and into the Dortye, will strap the jam to the door, for shipping.

Once installed a pre-hung door, needs a doorknob installed, so to latch the door closed. Most doors just installed do not get a doorknob installed right away, because the door needs to be painted or sealed.

The Dortye solves this problem. When you have installed the door, the Dortye stays in the door and works as the doorknob and latch piston. It allows the door to latch into the doorknob latch hole in the jam, so to latch the door closed. Sliding the Dortye side to side, will allow the door to latch or unlatch, to open or close the door as needed.

### BRIEF SUMMARY OF THE INVENTION

A part sized and manufactured from plastic to be; a door to jam shipping strap, a doorknob, and a doorknob-latching bolt.

When constructing a pre-hung door unit. By installing the Dortye into the doorknobs latch borehole, it allows, the headed lock tie to be put threw the jam, and into the Dortye. This straps the jam to its door, for shipping.

With a pre-hung door installed, by keeping the Dortye in the door, it will work as a temporary doorknob and latch piston. This will allow the door to be latched, or unlatched.

### BRIEF DESCRIPTION OF THE SEVERAL VIEWS OF THE DRAWINGS

FIG. 1

Is Dortye the “T” shaped part, and its headed, locking, strap tie

FIG. 2

How to fold the Dortye

FIG. 3

The Dortye folded

FIG. 4

A cut section of a door jam, Dortye folded to be installed, into a cut section of a door

FIG. 5

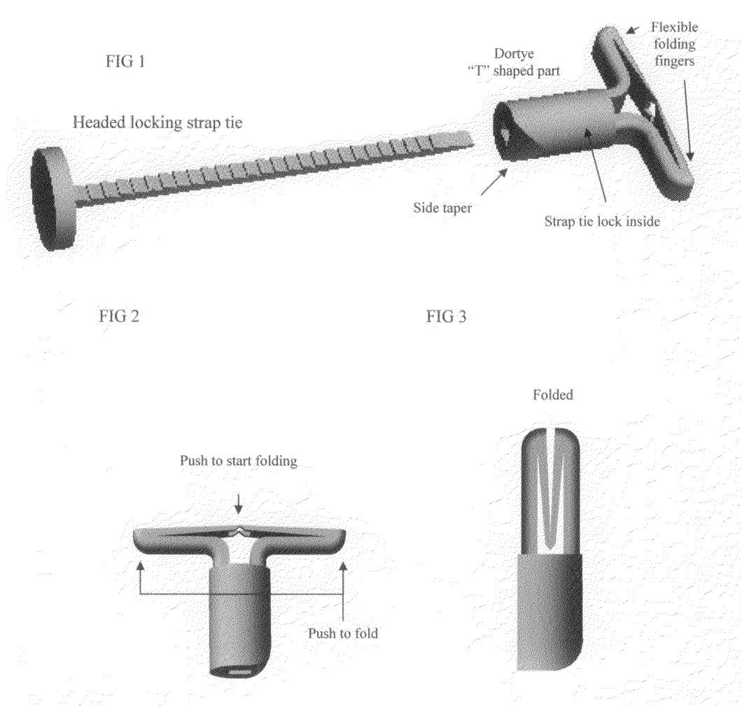

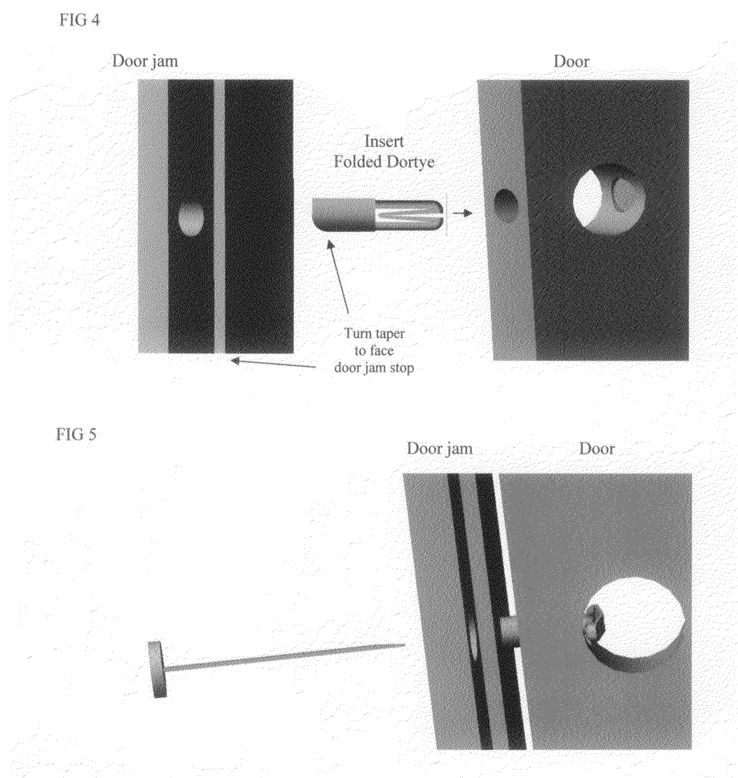

Shows Dortye installed into a cut section of a door, with a cut section of jam, showing, headed, locking, strap tie, install point.

### DETAILED DESCRIPTION OF THE INVENTION

My invention is two plastic parts, manufactured by filling a mold with molten plastic. Remove the parts from the mold, once it cools.

My invention is made of two parts.

Part one is Dortye; it is a “t” shaped part, made from soft molded plastics.

You can mold each part to any size.

A. Sizing so to fit varying “doorknob” set back measurements.

B. Sizing so to fit varying, “knob piston” borehole sizes

What makes this “t” shape?

It is a round cylinder, the bottom has an opening for the input of the headed, locking, strip tie, and witch will lock in side, once installed.

This cylinder has a 0.25″×0.375″ taper to one side; this taper slides, on the, piston latch plate, on the door jam, when the door is to be, latched closed.

On the top of this cylinder, there is what I call, flexible, folding, fingers. There are two fingers that come up from the top, on opposite sides and bend 90* angle to the side, they protrude 1.50″ out from the center of part. Then back to the center where they connect to each other.

These flexible, folding, finger, are just that. While folding the finger, install it into the cylinder borehole.

To fold the fingers in, you have to push downwards on the top of the folding finger; this lets the folding fingers fold into the center. While pushing down on the top, and push up on the bottom outer edge, of the folding fingers, to fold.

When you have fully folded up the flex fingers, you can install it, flex finger end first, into a latch piston borehole.

Once fully inserted into the latch piston borehole, the folding fingers will unfold, open and out to ether side of the door. Out threw the doorknob borehole.

The part of the folding fingers that protrude out threw the doorknob borehole, will become your doorknob, it will allow a person, on ether side of the door, to operate the Dortye to latch or unlatch the door.

The bottom of the cylinder will protrude out from the edge of the door. This is what latches into the door jam, latch borehole.

Part number two

To strap the door to the jam for shipping, you will need part number two.

Part number two is a headed, locking, strap tie, made from soft molded plastics. By molding this headed, locking, strap, with ridges, it locks into the “T” shaped part. One end of this strip is molded, to have a point, and the other end has a head, a stop cap end, it is ⅛″ thick and 1¼″ round.

To install the headed, locking, strap tie, insert the point end first. The door jam has a latch borehole, install the headed, locking, strap tie, in from the outer side, of the jam, into the bottom end of the “T” shaped part installed in the knob hole. Pull extra strap tie out from the top of the “T” shaped part, to tighten. The headed end cap on the strap tie holds the door jam.

By installing the headed, locking, strap tie, the tip of the locking strap will flex, pushing off the hinge side of the doorknob borehole. This pushes the Dortye towards the latch edge of door.

What I claim to be my invention is:

1. A sizeable door to jam shipping strap; whereas a headed, locking, strap tie, installed threw the jam, can lock into the Dortye door knob latch piston, to strap a jam to its door for shipping,
A sizeable door knob; whereas having two flexible folding fingers that work as a door knob, once inserted, into the doorknob latch piston bore hole,
A sizeable doorknob latching piston bolt, whereas a doorknob latching piston bolt, molded in any size, molded to be flexible, and foldable.

2. As recited in claims one,
Wherein to insert into the doorknob latch piston bore hole, whereas a doorknob latch piston can flex and fold, so to be inserted into the latch piston bore hole,
Out threw the doorknob borehole; whereas the two flexible folding fingers protrude out, ether side of the door,
to fit other door knob latch piston bore hole sizes; whereas the door knob latch piston size can be molded to any size,
Whereas to be a doorknob latch piston wherein to work as a door knob and a door to jam shipping strap.

3. As recited in claim one
Molded to size, so to fit doors with different knob setback measurements, whereas the doorknob latch piston molded to any size,
Flexible fms whereas the latch piston shaft has flexible fins that fold,
Straps the jam, for shipping; whereas a headed, locking, strap tie, locks into the Dortye,
Used to latch or unlatch a door whereas to secure a door, with a piston latch.
